(19) United States
(12) Patent Application Publication
(10) Pub. No.: US 2026/0205843 A1
(43) Pub. Date: Jul. 16, 2026

(54) QUALITY OF SERVICE SUSTAINABILITY IN A WIRELESS COMMUNICATION NETWORK

(71) Applicant: LENOVO (SINGAPORE) PTE. LTD., Singapore (SG)

(72) Inventors: Dimitrios KARAMPATSIS, Ruislip (GB); Emmanouil PATEROMICHELAKIS, Viersen (DE); Razvan-Andrei STOICA, Essen (DE)

(21) Appl. No.: 19/138,488

(22) PCT Filed: Feb. 24, 2023
(86) PCT No.: PCT/EP2023/054718

§ 371 Date: Jun. 12, 2025

(30) Foreign Application Priority Data
Dec. 16, 2022 (GR) 20220101049

(51) Int. Cl. H04W 24/08

(52) U.S. Cl. CPC H04W 24/08

(57) ABSTRACT

There is provided a method in a network node of a wireless communication system, the method comprising: receiving a request from an analytics consumer, the request comprising a PDU-set quality requirement, the request for analytics of quality of service sustainability for any QoS flow established satisfying the PDU-set quality requirement; collecting network performance data from at least one other network node; deriving from the network performance data, quality of service sustainability analytics; and sending the quality of service sustainability analytics to the analytics consumer.

### FIELD

The subject matter disclosed herein relates generally to the field of implementing quality of service (QoS) sustainability in a wireless communication network. This document defines a network node for wireless communication, a method in a network node of a wireless communication system, a consumer of quality of service sustainability analytics in a wireless communication network, and a method in a consumer of quality of service sustainability analytics.

### INTRODUCTION

Herein, extended Reality (XR) is used as an umbrella term for different types of realities of which Virtual Reality, Augmented Reality, and Mixed Reality are examples.

XR application traffic is subject to strict bandwidth and latency limitations in order to deliver an appropriate Quality of Service and Quality of Experience to an end user of an XR service. Such strict bandwidth and latency limitations can make delivery of XR application traffic over a wireless communication network challenging.

### SUMMARY

In the context of XR media traffic, 3GPP SA2 Work Group recently introduced the concept of a ‘PDU set’ to group a series of PDUs carrying a unit of information at the application-level. Each PDU within a PDU set can thus be treated according to an identical set of QoS requirements and associated constraints of delay budget and error rate while providing support to a RAN for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

There is required a mechanism to allow a consumer of analytics information to determine if PDU-set QoS requirements requested for a video application are sustainable. Further, the consumer may wish to determine if the user service experience is acceptable. Such determinations may be usefully provided for a specific area, time period. Based on such analytics information, the consumer might determine to upgrade the requested PDU-set QoS requirements to improve the performance of the video application when traffic is routed via the 5GS system.

Disclosed herein are procedures for quality of service (QoS) sustainability in a wireless communication network. Said procedures may be implemented by a network node for wireless communication, a method in a network node of a wireless communication system, a consumer of quality of service sustainability analytics in a wireless communication network, and a method in a consumer of quality of service sustainability analytics.

Accordingly, there is provided a network node for wireless communication, the network node comprising a processor; and a memory coupled with the processor. The processor is configured to cause the network node to: receive a request from an analytics consumer, the request comprising a PDU-set quality requirement, the request for analytics of quality of service sustainability for any QoS flow established satisfying the PDU-set quality requirement; collect network performance data from at least one other network node; derive from the network performance data, quality of service sustainability analytics; and send the quality of service sustainability analytics to the analytics consumer.

There is further provided a method in a network node of a wireless communication system, the method comprising: receiving a request from an analytics consumer, the request comprising a PDU-set quality requirement, the request for analytics of quality of service sustainability for any QoS flow established satisfying the PDU-set quality requirement; collecting network performance data from at least one other network node; deriving from the network performance data, quality of service sustainability analytics; and sending the quality of service sustainability analytics to the analytics consumer.

There is further provided a consumer of quality of service sustainability analytics in a wireless communication network, the consumer comprising: a processor; and a memory coupled with the processor. The processor is configured to cause the consumer to: send to a network node a request, the request comprising a PDU-set quality requirement, the request for analytics of quality of service sustainability for any QoS flow established satisfying the PDU-set quality requirement; and receive from the network node quality of service sustainability analytics.

There is further provided a method in a consumer of quality of service sustainability analytics, the method comprising: sending to a network node a request, the request comprising a PDU-set quality requirement, the request for analytics of quality of service sustainability for any QoS flow established satisfying the PDU-set quality requirement; and receiving from the network node quality of service sustainability analytics.

Such an arrangement allows the analytics consumer to determine if QoS requirements with specific QoS requirements for a PDU-set can be satisfied. Such a determination may be made in respect of a specific area and/or time period. Based on the analytic information received from the network node, the analytics consumer may elect to make a corrective action. Such a corrective action may comprise upgrading PDU-set QoS requirements to improve the performance of the service when traffic carrying data for the service is routed via the 5GS system.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for implementing quality of service (QoS) sustainability in a wireless communication network will now be described, by way of example only, with reference to the accompanying drawings, in which:

FIG. 1 depicts an embodiment of a system for implementing quality of service (QoS) sustainability in a wireless communication network;

FIG. 2 depicts a user equipment apparatus;

FIG. 3 depicts further details of the network node;

FIG. 4 illustrates an overview of a core network architecture handling of PDU sets;

FIG. 5 illustrates an example wireless communication system;

FIG. 6 is a messaging diagram illustrating a procedure as described herein;

FIG. 7 illustrates a method in a network node of a wireless communication system; and

FIG. 8 illustrates a method in a consumer of quality of service sustainability analytics.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

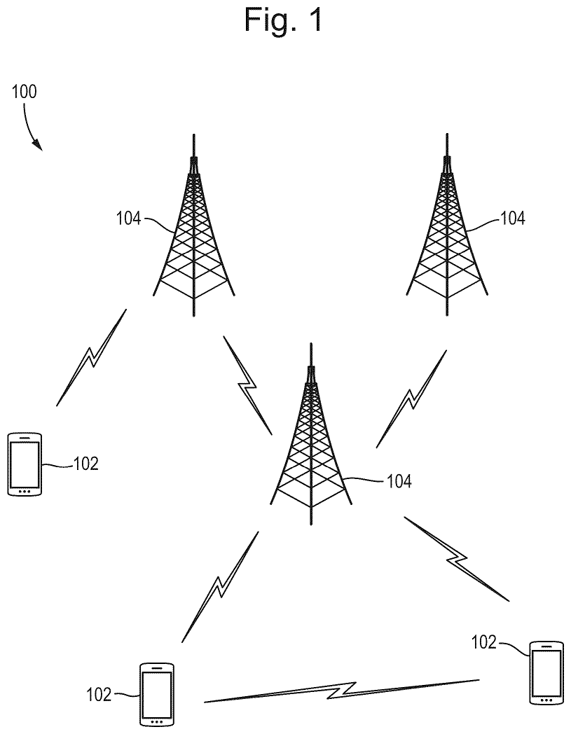

FIG. 1 depicts an embodiment of a wireless communication system 100 for implanting quality of service (QoS) sustainability in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The remote unit 102 may be embodied as a user equipment apparatus 200, a UE 435, and/or a UE 504 as described herein. The network unit 104 may be embodied as a network node 300, a RAN 430, an NWDAF 1 510, an NWDAF 2 512, and/or an NWDAF 610 as described herein.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

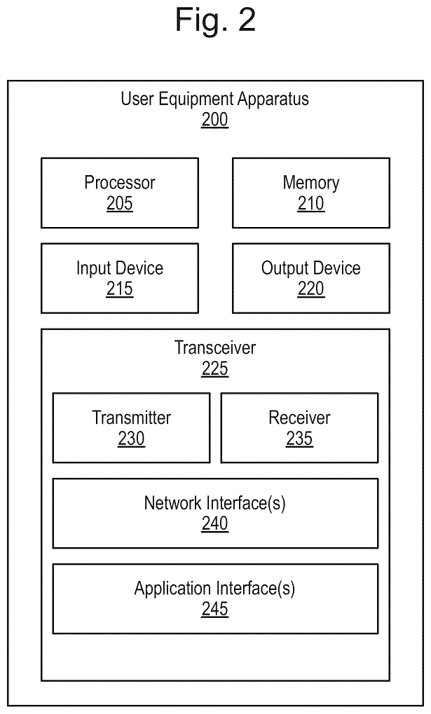

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be embodied as a remote unit 102, UE 435, and/or a UE 504 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

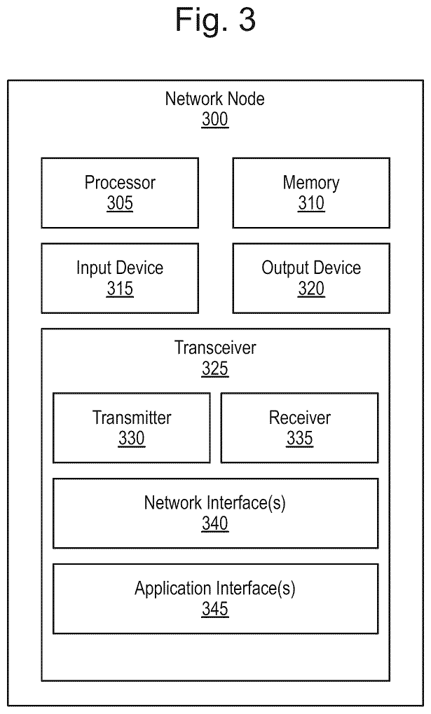

FIG. 3 depicts further details of the network node 300 that may be used for implementing the methods described herein. The network node 300 may be one implementation of an entity in the wireless communication network, e.g. in one or more of the wireless communication networks described herein. The network node 300 may be embodied as a network unit 104, a RAN 430, an NWDAF 1 510, an NWDAF 2 512, and/or an NWDAF 610 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In Release 18, 3GPP is studying enhancements to support XR (extended reality) media within 3GPP core network. The main principle of solutions being discussed is to allow the core network to guarantee delivery of media packets that are important at the application level for recovering the media traffic even when the media packet is sent via a best effort bearer.

Most of the solutions proposes in 3GPP SA2 propose that the network identify important packets in a PDU-set. The PDU-set terminology in 3GPP TR 23.700-60 is as follows:
PDU Set: A PDU Set is composed of one or more PDUs carrying the payload of one unit of information generated at the application level (e.g. a frame or video slice for XRM Services, as used in TR 26.926. In some implementations all PDUs in a PDU Set are needed by the application layer to use the corresponding unit of information. In other implementations, the application layer can still recover parts all or of the information unit, when some PDUs are missing.

PDU-set specific QoS requirements may be defined that are either pre-configured in the 3GPP core network or provided by an AF. The QoS requirements for a PDU-set my be defined using any combination of the following parameters:
PDU Set Delay Budget (PSDB);
PDU Set Error Rate (PSER); and
Whether a PDU is essential.

PDU Set Delay Budget (PSDB) defines an upper bound for the time that a PDU-Set may be delayed between the UE and the N6 termination point at the UPF. PSDB applies to the DL PDU-Set received by the UPF over the N6 interface, and to the UL PDU-Set sent by the UE,

PDU Set Error Rate (PSER) defines a ratio of dropped PDU-set by NG-RAN compared to total PDU-set sent to the UE.

Whether a PDU is essential indicates whether all PDUs of a PDU-set are required by a receiver.

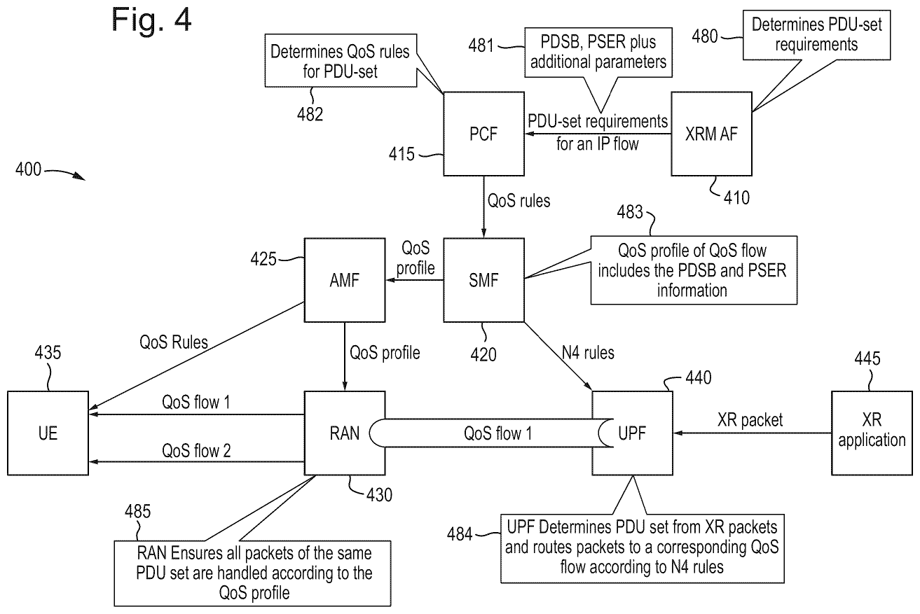

The packets belonging to a PDU-set are handled by the core network as shown in FIG. 4 which illustrates an overview of a core network (CN) XRM architecture handling of PDU sets. FIG. 4 shows a system 400 comprising an Extended Reality Media Application Function (XRM AF) 410, a Policy and Control Function (PCF) 415, a Session Management Function (SMF) 420, an Access and Mobility Function (AMF) 425, a Radio Access Network (RAN 430, a User Equipment (UE) 435, a User Plane Function (UPF) 440, and an Extended Reality Application 445. The UE 435 may comprise a remote unit 102 or a user equipment apparatus 200 as described herein. The RAN 430 may comprise a base unit 104, a network node 300, an NWDAF 1 510, an NWDAF 2 512, and/or an NWDAF 610 as described herein. The operation of system 400 will now be described in the example of downlink traffic, a similar process may operate for uplink traffic.

At 480, the XRM AF 410 determines PDU set requirements.

At 481, the XRM Application Function 410 provides QoS requirements for packets of a PDU set to the PCF 415 and information to identify the application (i.e. 4-tuple or application id). The QoS requirements may comprise PSDB and PSER. The XRM AF 410 may also include an importance parameter for a PDU set and information for the core network to identify packets belonging to a PDU set.

At 482, the PCF 415 derives QoS rules for the XR application and specific QoS requirements for the PDU set. The QoS rules may use a 4G QoS identifier (5QI) for XR media traffic. The PCF 415 sends the QoS rules to the SMF 420. The PCF 415 may include in the communication to the SMF 420 Policy and Charging Control (PCC) rules per importance of a PDU set. The PCC rules may be derived according to information received from the XRM AF 410 or based on an operator configuration.

At 483, the SMF 420 establishes a QoS flow according to the QoS rules by the PCF 415 and configures the UPF to route packets of the XR application to a QoS flow, and, in addition, to enable PDU set handling. The SMF 420 also provides the QoS profile containing PDU set QoS requirements to the RAN 430 via the AMF 425. The AMF 425 may provide the QoS profile containing PDU set QoS requirements to the RAN 430 in an N2 Session Management (SM) container. Further, the AMF 425 may provide the QoS rules to the UE 435 in an N1 SM container.

At 484, the UPF 440 inspects the packets and determines packets belonging to a PDU set. The packet inspection may comprise inspecting the RTP packets. When the UPF 440 detects packets of a PDU set the UPF 440 marks the packets belonging to a PDU set within a GTP-U header. The GTP-U header information includes a PDU set sequence number and the size of the PDU set. The UPF 440 may also determine the importance of the PDU set either based on UPF 440 implementation means, information provided by the XRM AF 410 or information provided as metadata from an XRM application server. Based on the importance of the PDU set the UPF 440 may route the traffic to a corresponding QoS flow 1 (according to the rules received from the SMF 420) or include the importance of the PDU set within a GTP-U header. QoS flow 1 may comprise GTP-U headers, and these may include PDU set information.

At 485, the RAN 430 identifies packets belonging to a PDU set (based on the GTP-U marking) and handles the packets of the PDU set according to the QoS requirements of the PDU set provided by the SMF 420. RAN 430 may receive QFIs, QoS profile of QoS flow from SMF 420 (via AMF 425) during PDU session establishment/modification which includes PDSB and PSER. RAN 430 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 440 packet inspection is taken by the UE 435 which is expected to inspect uplink packets, determine packets belonging to a PDU set, and signal accordingly the PDU set to the RAN 430 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, extended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) titled “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

The following additional assumptions have also been agreed:
NG-RAN is the only entity that drops packet of a PDU-set in case of congestion.
For a QoS flow there can be multiple priority PDU-sets. The NG-RAN drops the lower priority PDU-sets in case of congestions.
The NG-RAN drops all PDUs of a PDU-set

In addition, 3GPP has defined in 3GPP TS 23.288 v17.2.0 an architecture to support providing network analytics. In the architecture the NWDAF provides analytic output to one or more Analytics Consumer NFs based on Data Collected from one or more Data Producer NFs.

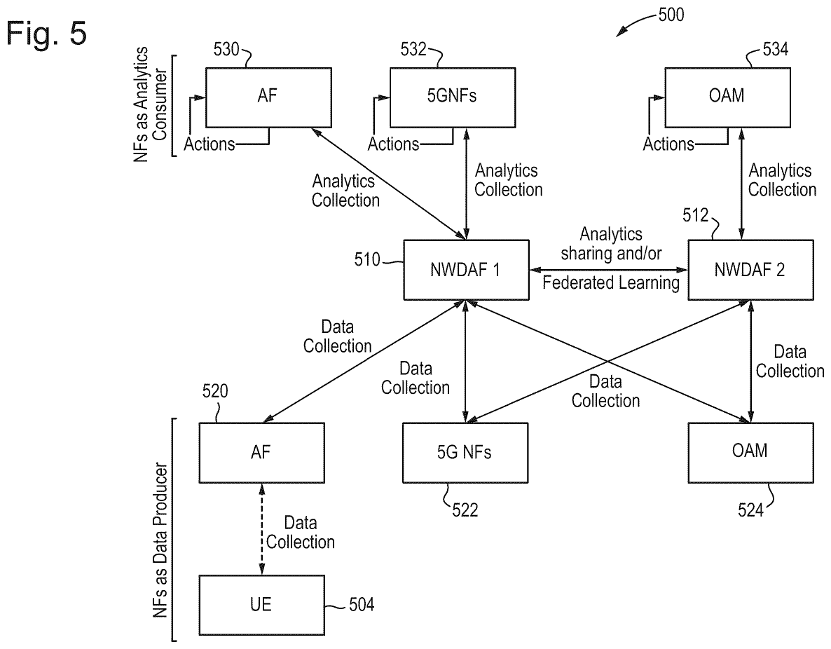

FIG. 5 illustrates an example wireless communication system 500. The system 500 comprises a UE 504, an NWDAF Analytics Logical Functions (ANLF) 510, a an NWDAF Model Training Logical Function (MTLF) 512, a plurality of Data Producer Network Functions, in this example am Application Function (AF) 520, a 5G Network Function 522, and an Operations, Administration and Maintenance (OAM) 524. The wireless communication system 500 further comprises a plurality of Analytics Consumer Network Functions which in this example include an Application Function 530, a 5G Network Function 532, and an OAM 534. In the current Release 16 and Release 17 3GPP architecture, the NWDAFs 510, 512 (defined in 3GPP Technical Specification 23.288 v17.2.0) provide analytic output to one or more of the Analytics Consumer NFs 530, 532, and 534 based on data collected from one or more Data Producer NFs 520, 522 and 524. The analytic output may be derived by the NWDAFs 510, 512 using Analytics sharing and/or Federated Learning. The UE 504 may be embodied as a remote unit 102, a user equipment apparatus 200, and/or a UE 435 as described herein. The NWDAF 1 510 and NWDAF 2 512, may be embodied as a network unit 104, a network node 300, a RAN 430, and/or an NWDAF 610 as described herein.

The Analytics Consumer NF may be one or more of an AF, OAM and 5G Core NFs (e.g., SMF, AMF, PCF). A full list of potential Analytics Consumer NF for each Analytics output the NWDAF provides is described in table 1 below.

TABLE 1
Example Analytics Consumer NFs

| NWDAF Analytics Output | Example Analytics Consumer NF |
|---|---|
| Slice Load Level | PCF, NSSF |
| Observed Service Experience | PCF, OAM |
| NF load analytics | All 5G core NFs, OAM |
| Network Performance Analytics | PCF, NEF, AF, or OAM |
| UE Mobility Analytics | AMF, SMF |
| UE Communication Analytics | AMF, SMF, PCF |
| Expected UE behavioural analytics | AMF, UDM, AF or OAM |
| Abnormal behaviour analytics | AMF, SMF, PCF |
| User Data Congestion analytics | NEF, AF |
| QoS Sustainability Analytics | AF |

In particular, to support XR services, the following analytics are relevant to this disclosure. Such analytics can be beneficial for mobile XR users, or for the XR service provider/vertical who needs to deploy the XRM service in a target area and time (e.g. for an event) and who requires the statistics/predictions on the QoS/network performance and availability.

QoS Sustainability Analytics may provide information regarding the QoS change statistics for an Analytics target period in the past in a certain area. These may additionally or alternatively provide information regarding the likelihood of a QoS change for an Analytics target period in the future in a certain area.

Network Performance Analytics may provide either statistics or predictions on the gNB status information, gNB resource usage, communication performance and mobility performance in an Area of Interest.

User Data Congestion Analytics may relate to congestion experienced while transferring user data over the control plane or user plane or both.

The solutions proposed herein provide enhanced network analytics to allow a consumer (e.g. PCF or AF) to be aware how PDU-set marking affects the performance of the network and/or the observed service experience of an application.

The consumer provides within analytic filter information the 5QI and in addition the PDU-Set QoS requirements. Upon receipt, the NWDAF determines and provides analytics which indicate whether a 5QI with specific PDU-set QoS requirements is sustainable for an analytics target period in a certain area.

When the NWDAF collects input data to determine QoS sustainability analytics then in addition to input data specified in clause 6.9.2 of 3GPP TS 23.288 v17.2.0, the NWDAF may additionally collect the following information:

From an SMF: QoS Flow Identifier of the QoS flow that includes the requested PDU-set QoS requirements;

From an UPF/OAM: Observed PDU-set packet delay/PDU-set error rate, ratio of higher/lower importance PDU-sets, average size of PDU-sets; and/or

From an OAM/RAN or RAN monitoring entity: Percentage of discarded PDU-Sets in the NG-RAN, average size of PDU-set and similar statistics filtered by aggregation based on the PDU-set priority/importance levels as signaled for instance in the GTP-U header over N3 interface to RAN (e.g., average size of PDU sets and percentage of discarded PDU sets for high-importance PDU sets, such as video coded I-frames/slices/tiles).

The output analytics from the NWDAF may provide crossed reporting thresholds indicating thresholds that are met or exceeded or crossed based on the expected PDU-set QoS requirement or target.

With the QoS Sustainability Analytics the consumer can determine if the PDU-set QoS requirements/targets for a QoS flow are sustainable, and may make an adjustment accordingly. For example, the consumer may adjust the requested PDU-set QoS requirements or adjust the quality of the video (e.g. adjust frame rate, codec configuration, codec etc.).

Additionally, the consumer (for example an AF) may carry out the following actions:
Change encoder configuration
Change PDU-set grouping configuration
Change FEC codec redundancy or source block size

Furthermore, if the application server has the capability to include PDU-set information within RTP headers, the application server may encode differently the PDU-set information within RTP header information taking into account analytics provided to it by the NWDAF.

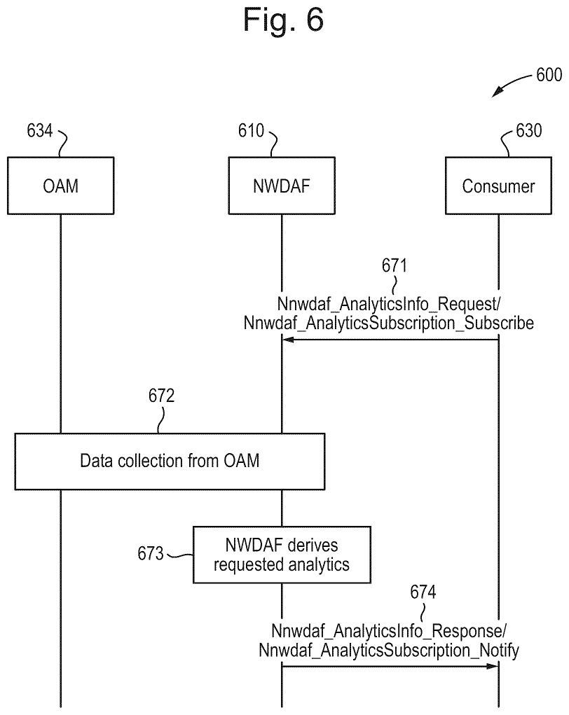

FIG. 6 is a messaging diagram illustrating a procedure 600 as described herein. The procedure 600 is an example of enhanced QoS sustainability analytics with PDU-set QoS sustainability analytics. FIG. 6 shows a Consumer 630, a Network Data Analytics Function (NWDAF) 610, and, as an example of a Network Function from which data is collected, an Operations, Administration and Maintenance (OAM) 634. The consumer 630 may be a further Network Function. The NWDAF 610 may be embodied as a network unit 104, a network node 300, a RAN 430, an NWDAF 1 510, and/or an NWDAF 2 512 as described herein.

The process 600 is illustrated in FIG. 6 with the specific example of the NWDAF 610 collecting input data from the OAM 634. The data collection step may comprise collecting data from one or more Network Functions. Furthermore, the data collection step may comprise collecting data from a RAN monitoring entity.

The procedure 600 begins at 671, where the Consumer 630 request QoS sustainability analytics for PDU-set QoS requirements, i.e. whether the requested PDU-set QoS requirements can be supported in a target area over a time period as per 3GPP TS 23.288 v17.2.0 clause 6.9. The consumer 630 additionally includes PDU-set QoS requirements as analytic filters in the request. The request may include an analytics identity. The analytics identity may comprise a quality-of-service Analytic Filter, which may take the form of a PDU set QoS requirement. The request may take the form of “Nnwdaf_AnalyticsInfo_Request/Nnwdaf_AnalyticsSubscription_Subscribe”.

At 672, the NWDAF 610 collects input data from UPF/OAM/SMF/RAN or RAN monitoring entity as per clause 6.9 of 3GPP TS 23.288 v17.2.0. The NWDAF 610 determines the UPF that carries out PDU-set marking serving the UE by querying the SMF. The NWDAF 610 additionally collects one or more of the following: Observed PDU-set packet delay/PDU-set error rate, ratio of higher/lower importance PDU-sets, Percentage of discarded PDU-Sets in the NG-RAN, average size of PDU-set. The data collection from the OAM 634 may further comprise additional input of PDU-set QoS performance.

At 673, the NWDAF 610 derives analytics taking into account the additional information based on the analytic filters requested in step 671.

At 674, the NWDAF 610 provides analytic info to the consumer. Such notification may take the form of “Nnwdaf_AnalyticsInfo_Response/Nnwdaf_AnalyticsSubscrip-tion_Notify”.

Network performance analytics may be based on PDU-set QoS requirements. The network performance analytics provides analytics on the gNB status information and gNB resource usage in an area of interest. The analytics can be enhanced to provide information on the gNB status based on handling of PDU-set packets. The consumer may additionally include in the request analytic filter information. The analytic filter information indicates that gNB resource usage for packets belonging to a PDU-set should be provided. The analytic information from the NWDAF can provide an indication of the percentage of resources used to handle packets of PDU-sets compared to resources used for non-PDU-set packets.

When the NWDAF collects input data to determine network performance analytics the NWDAF in addition to input data specified in clause 6.6.2 of 3GPP TS 23.288 v17.2.0 and additionally collects the any combination of the following information collected from the indicated node:
OAM: Radio resource usage utilisation for packets of a PDU-set;
OAM: Assigned resources (CPU, memory, disk) when handling packets of the indicated PDU-set(s);
OAM/RAN or RAN monitoring entity: Assigned resources (CPU, memory, disk) when handling packets of the indicated PDU-set(s);
OAM/RAN or RAN monitoring entity: Percentage of discarded PDU-Sets in the NG-RAN, average size of PDU-set for different importance PDU-set within the same QoS flow; and or
OAM/RAN or RAN monitoring entity: Ratio of resources used for different importance PDU-set within the same QoS flow.

The output analytics from the NWDAF can provide a ratio of resources used to handle packets of a PDU-set compared to normal packets (packets that do not belong to a PDU-set).

User data congestion analytics based on PDU-set QoS requirements. User Data Congestion related analytics can relate to congestion experienced while transferring user data over the control plane or user plane or both.

The user data congestion analytics are enhanced to allow the NWDAF to provide analytics when the user transfers user data related to an XR service (a communication session between the UE and an application service that contains XR related services/media).

When an analytics consumer requests user data congestion analytics, the consumers additionally include from the analytic filter information specific in clause 6.81 of 3GPP TS 23.228 v17.2.0 the following information: a list of Applications using PDU-set marking that experience congestion.

The NWDAF additionally collects as input data from the input data specified in clause 6.8.2 of 3GPP TS 23.288 v17.2.0 the following information: SMF/UPF: Application identifier or IP packet filter set that is PDU-set marked by the UPF or AS.

The output analytics from the NWDAF may include the list of top applications, the list PDU-set marked in the 5G network that experiences congestion. The consumer may use this information to determining different PDU-set QoS targets.

Accordingly, there is provided a network node for wireless communication, the network node comprising a processor; and a memory coupled with the processor. The processor is configured to cause the network node to: receive a request from an analytics consumer, the request comprising a PDU-set quality requirement, the request for analytics of quality of service sustainability for any QoS flow established satisfying the PDU-set quality requirement; collect network performance data from at least one other network node; derive from the network performance data, quality of service sustainability analytics; and send the quality of service sustainability analytics to the analytics consumer.

The network node may comprise an analytics function. The network node may comprise an NWDAF. The network function may comprise an application function.

Such an arrangement allows the analytics consumer to determine if QoS requirements with specific QoS requirements for a PDU-set can be satisfied. Such a determination may be made in respect of a specific area and/or time period. Based on the analytic information received from the network node, the analytics consumer may elect to make a corrective action. Such a corrective action may comprise upgrading PDU-set QoS requirements to improve the performance of the service when traffic carrying data for the service is routed via the 5GS system.

The PDU-set quality requirement may define a quality of service threshold. The PDU-set quality requirement may be defined as a 5G QoS Identifier (5QI). The 5G QoS Identifier (5QI) may comprise a pointer to a set of QoS characteristics such as priority level, packet delay or packet error rate, etc.

The PDU-set quality requirement may comprise a quality requirement for a class of PDU-set. The class of PDU-set may be defined as a PDU-set used for delivering a service. The class of PDU set may comprise a PDU-set used for delivering video.

The PDU-set quality requirement may comprise a PDU-set QoS requirement. The derived quality of service sustainability analytics are filtered so as to be limited to QoS flows satisfying the PDU-set quality requirement.

The PDU-set quality requirement comprises at least one of: a QoS target for packet data units; a specific quality for PDU-set delivery; a PDU-set Delay Budget; a PDU-set error rate; and/or a quality of service threshold.

The QoS target may comprise QoS requirements for a PDU-set. The PDU-set may deliver data for the service. The PDU-set QoS requirements may comprise PDU-set Delay Budget and PDU-set error rate.

If the quality of service threshold is not met, triggers a notification to be sent from the network node to the analytics consumer.

The network performance data may comprise the observed performance of a QoS flow established with the PDU-set quality requirement.

The observed performance of the QoS flow established with a specific PDU-set QoS requirements may comprise any combination of: PDU-set packet delay; PDU-set error rate; a ratio of identified PDU-sets compared to PDUs not belonging to a PDU-set; a ratio of higher and/or lower importance PDU-sets; a percentage of discarded PDU-Sets in the wireless communication system; and/or an average size of a PDU-set.

The percentage of discarded PDU-Sets in the NG-RAN may be obtained from an OAM. The average size of PDU-set may be derived from an OAM.

The at least one other network node may comprise any of: one or more network functions; a RAN monitoring entity; and/or an OAM. The one or more network functions may comprise an SMF and/or a UPF.

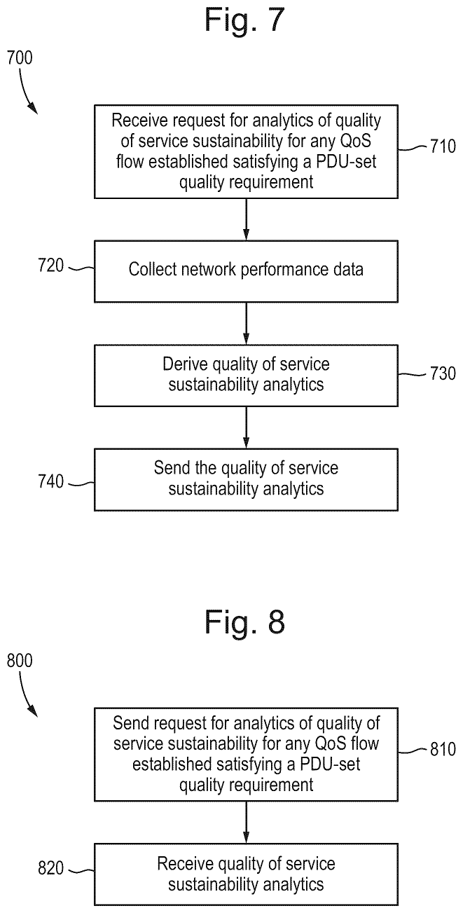

FIG. 7 illustrates a method 700 in a network node of a wireless communication system, the method 700 comprising: receiving 710 a request from an analytics consumer, the request comprising a PDU-set quality requirement, the request for analytics of quality of service sustainability for any QoS flow established satisfying the PDU-set quality requirement; collecting 720 network performance data from at least one other network node; deriving 730 from the network performance data, quality of service sustainability analytics; and sending 740 the quality of service sustainability analytics to the analytics consumer.

In certain embodiments, the method 700 may be performed by a processor executing program code, for example, a microcontroller, a microprocessor, a CPU, a GPU, an auxiliary processing unit, a FPGA, or the like.

The network node may comprise an analytics function. The network node may comprise an NWDAF. The network function may comprise an application function.

Such an arrangement allows the analytics consumer to determine if QoS requirements with specific QoS requirements for a PDU-set can be satisfied. Such a determination may be made in respect of a specific area and/or time period. Based on the analytic information received from the network node, the analytics consumer may elect to make a corrective action. Such a corrective action may comprise upgrading PDU-set QoS requirements to improve the performance of the service when traffic carrying data for the service is routed via the 5GS system.

The PDU-set quality requirement may define a quality of service threshold. The PDU-set quality requirement may be defined as a 5G QoS Identifier (5QI). The 5G QoS Identifier (5QI) may comprise a pointer to a set of QoS characteristics such as priority level, packet delay or packet error rate, etc.

The PDU-set quality requirement may comprise a quality requirement for a class of PDU-set. The class of PDU-set may be defined as a PDU-set used for delivering a service. The class of PDU set may comprise a PDU-set used for delivering video. The PDU-set quality requirement may comprise a PDU-set QoS requirement.

The derived quality of service sustainability analytics may be filtered so as to be limited to QoS flows satisfying the PDU-set quality requirement. The PDU-set quality requirement may comprise at least one of: a QoS target for packet data units; a specific quality for PDU-set delivery; a PDU-set Delay Budget; a PDU-set error rate; and/or a quality of service threshold.

The QoS target may comprise QoS requirements for a PDU-set. The PDU-set may deliver data for the service. The PDU-set QoS requirements may comprise PDU-set Delay Budget and PDU-set error rate.

If the quality of service threshold is not met, triggers a notification to be sent from the network node to the analytics consumer.

The network performance data may comprise the observed performance of a QoS flow established with the PDU-set quality requirement. The QoS flow established with a specific PDU-set QoS requirements may comprise any combination of: PDU-set packet delay; PDU-set error rate; a ratio of identified PDU-sets compared to PDUs not belonging to a PDU-set; a ratio of higher and/or lower importance PDU-sets; a percentage of discarded PDU-Sets in the wireless communication system; and/or an average size of a PDU-set. The percentage of discarded PDU-Sets in the NG-RAN may be obtained from an OAM. The average size of PDU-set may be derived from an OAM.

The at least one other network node comprises any of: one or more network functions; a RAN monitoring entity; and/or an OAM. The one or more network functions may comprise an SMF and/or a UPF.

There is further provided a consumer of quality of service sustainability analytics in a wireless communication network, the consumer comprising: a processor; and a memory coupled with the processor. The processor is configured to cause the consumer to: send to a network node a request, the request comprising a PDU-set quality requirement, the request for analytics of quality of service sustainability for any QoS flow established satisfying the PDU-set quality requirement; and receive from the network node quality of service sustainability analytics. The consumer may be an Application Function (AF).

Such an arrangement allows the analytics consumer to determine if QoS requirements with specific QoS requirements for a PDU-set can be satisfied. Such a determination may be made in respect of a specific area and/or time period. Based on the analytic information received from the network node, the analytics consumer may elect to make a corrective action. Such a corrective action may comprise upgrading PDU-set QoS requirements to improve the performance of the service when traffic carrying data for the service is routed via the 5GS system.

The consumer may be further arranged to determine whether the PDU-set quality requirement for a QoS flow is sustainable. The consumer may be further arranged to determine that the PDU-set quality requirement for a QoS flow is unsustainable, and as a result adjusting the requested PDU-set quality requirement for the QoS flow.

Adjusting the requested PDU-set quality requirement for the QoS flow may comprise at least one of: adjusting the quality of a video carried by the QoS flow; change an encoder configuration; change a PDU-set grouping configuration; change a Forward Error Correction (FEC) codec redundancy; and/or change a source block size. Adjusting a video quality may comprise adjusting a frame rate, a codec configuration, or codec used, for example.

The PDU-set quality requirement may define a quality of service threshold. The PDU-set quality requirement may be defined as a 5G QoS Identifier (5QI). The 5G QoS Identifier (5QI) may comprise a pointer to a set of QoS characteristics such as priority level, packet delay or packet error rate, etc.

The PDU-set quality requirement may comprise a quality requirement for a class of PDU-set. The class of PDU-set may be defined as a PDU-set used for delivering a service. The class of PDU set may comprise a PDU-set used for delivering video. The PDU-set quality requirement may comprise a PDU-set QoS requirement.

The derived quality of service sustainability analytics are filtered so as to be limited to QoS flows satisfying the PDU-set quality requirement. The PDU-set quality requirement may comprise at least one of: a QoS target for packet data units; a specific quality for PDU-set delivery; a PDU-set Delay Budget; a PDU-set error rate; and/or a quality of service threshold.

The QoS target may comprise QoS requirements for a PDU-set. The PDU-set may deliver data for the service. The PDU-set QoS requirements may comprise PDU-set Delay Budget and PDU-set error rate. If the quality of service threshold is not met, triggers a notification to be sent from the network node to the analytics consumer.

FIG. 8 illustrates a method 800 in a consumer of quality of service sustainability analytics, the method 800 comprising: sending 810 to a network node a request, the request comprising a PDU-set quality requirement, the request for analytics of quality of service sustainability for any QoS flow established satisfying the PDU-set quality requirement; and receiving 820 from the network node quality of service sustainability analytics. The consumer may be an Application Function (AF).

In certain embodiments, the method 800 may be performed by a processor executing program code, for example, a microcontroller, a microprocessor, a CPU, a GPU, an auxiliary processing unit, a FPGA, or the like.

Such an arrangement allows the analytics consumer to determine if QoS requirements with specific QoS requirements for a PDU-set can be satisfied. Such a determination may be made in respect of a specific area and/or time period. Based on the analytic information received from the network node, the analytics consumer may elect to make a corrective action. Such a corrective action may comprise upgrading PDU-set QoS requirements to improve the performance of the service when traffic carrying data for the service is routed via the 5GS system.

The method may further comprise determining whether the PDU-set quality requirement for a QoS flow is sustainable. The method may further comprise determining that the PDU-set quality requirement for a QoS flow is unsustainable, and as a result adjusting the requested PDU-set quality requirement for the QoS flow.

Adjusting the requested PDU-set quality requirement for the QoS flow may comprise at least one of: adjusting the quality of a video carried by the QoS flow; change an encoder configuration; change a PDU-set grouping configuration; change a Forward Error Correction (FEC) codec redundancy; and/or change a source block size.

Adjusting a video quality may comprise adjusting a frame rate, a codec configuration, or codec used, for example. The PDU-set quality requirement may define a quality of service threshold. The PDU-set quality requirement may be defined as a 5G QoS Identifier (5QI). The 5G QoS Identifier (5QI) may comprise a pointer to a set of QoS characteristics such as priority level, packet delay or packet error rate, etc.

The PDU-set quality requirement may comprise a quality requirement for a class of PDU-set. The class of PDU-set may be defined as a PDU-set used for delivering a service. The class of PDU set may comprise a PDU-set used for delivering video.

The PDU-set quality requirement may comprise a PDU-set QoS requirement. The derived quality of service sustainability analytics may be filtered so as to be limited to QoS flows satisfying the PDU-set quality requirement.

The PDU-set quality requirement may comprise at least one of: a QoS target for packet data units; a specific quality for PDU-set delivery; a PDU-set Delay Budget; a PDU-set error rate; and/or a quality of service threshold.

The QoS target may comprise QoS requirements for a PDU-set. The PDU-set may deliver data for the service. The PDU-set QoS requirements may comprise PDU-set Delay Budget and PDU-set error rate.

If the quality of service threshold is not met, triggers a notification to be sent from the network node to the analytics consumer.

The solution described herein allows a consumer via analytics information to the NWDAF to determine if the PDU-set QoS requirements requested for a video application are sustainable in a specific area/time period and/or if the user service experience is acceptable. Based on the analytic information received the consumer can determine to upgrade the requested PDU-set QoS requirements to improve the performance of the video application when traffic is routed via the 5GS system.

The solution presented herein enhances the existing analytics provided by the NWDAF (QoS sustainability, network performance analytics) to additionally provide statistics or predictions when specific PDU-set QoS requirements are requested and/or a specific video quality is used for the video application traffic routed via the 5GS system.

The service experience, QoS sustainability, and network performance analytics provided by the NWDAF are already defined in 3GPP TS 23.288 v17.2.0 but they cannot be used to determine the performance of the network when PDU-set QoS requirements are requested.

PDU-Set QoS sustainability may be based on PDU-set QoS requirements. Network performance analytics may be based on PDU-set QoS requirements. User data congestion analytics may be derived for XR services.

There is provided herein a method wherein a network data analytics function receives a first request from an analytics consumer requesting QoS sustainability analytics for a QoS flow identified by a 5QI with specific PDU-set QoS targets/characteristics. The method further comprises determining to collect network performance data from a list containing at least one of one or more network functions [for example, SMF, UPF], a RAN monitoring entity or OAM wherein the data additionally includes the observed performance of QoS flows using a 5QI with specific PDU-set QoS targets. By way of example, the specific PDU-set QoS targets may comprise any combination of: observed PDU-set packet delay/PDU-set error rate, ratio of identified PDU-sets compared to PDUs not belonging to a PDU-set, ratio of higher/lower importance PDU-sets, and from the OAM, any combination of: Percentage of discarded PDU-Sets in the NG-RAN, average size of PDU-set. The method further comprises deriving QoS sustainability analytics and determining if the targets are sustainable.

The PDU-set QoS requirements may be PDU-set Delay Budget and PDU-set error rate.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: UE, User Equipment; PDU, Packet Data Unit; PDU-set, Packet Data Unit set; UL, Uplink; DL, Downlink; QoS, Quality of Service; XR, Extended Reality; PSDB, PDU Set Delay Budget; PDB, Packet Delay Budget; PSER, PDU Set Error Rate; NWDAF, Network Data Analytics Function; UPF, User Plane Function; SMF, Session Management Function; and OAM, Operations, Administration and Maintenance.

1. A network node for wireless communication, comprising:
at least one memory; and
at least one memory coupled with the at least one memory and configured to cause the network node to:
receive a request from an analytics consumer, the request comprising a protocol data unit (PDU)-set quality requirement, the request for analytics of quality of service sustainability for any quality of service (QoS) flow established satisfying the PDU-set quality requirement;
collect network performance data from at least one other network node;
derive, from the network performance data, quality of service sustainability analytics; and
send the quality of service sustainability analytics to the analytics consumer.

2. The network node of claim 1, wherein the PDU-set quality requirement defines a quality of service threshold.

3. The network node of claim 1, wherein the PDU-set quality requirement is defined as a 5G QoS Identifier (5QI).

4. The network node of claim 1, wherein the PDU-set quality requirement comprises a quality requirement for a class of PDU-set.

5. The network node of claim 1, wherein the PDU-set quality requirement comprises a PDU-set QoS requirement.

6. The network node of claim 1, wherein the derived quality of service sustainability analytics are filtered to be limited to QoS flows satisfying the PDU-set quality requirement.

7. The network node of claim 1, wherein the PDU-set quality requirement comprises at least one of:
a QoS target for packet data units;
a specific quality for PDU-set delivery;
a PDU-set Delay Budget;
a PDU-set error rate; or
a quality of service threshold.

8. The network node of claim 1, wherein the network performance data comprise an observed performance of a QoS flow established with the PDU-set quality requirement.

9. The network node of claim 8, wherein the observed performance of the QoS flow established with a specific PDU-set QoS requirements comprises any combination of:
PDU-set packet delay;
PDU-set error rate;
a ratio of identified PDU-sets compared to PDUs not belonging to a PDU-set;
a ratio of higher or lower importance PDU-sets;
a percentage of discarded PDU-Sets in a wireless communication system; or
an average size of a PDU-set.

10. The network node of claim 1, wherein the at least one other network node comprises:
one or more network functions;
a radio access network (RAN) monitoring entity; or
an operations, administration, and maintenance (OAM) entity.

11. A method performed by a network node of a wireless communication system, the method comprising:
receiving a request from an analytics consumer, the request comprising a protocol data unit (PDU)-set quality requirement, the request for analytics of quality of service sustainability for any quality of service (QoS) flow established satisfying the PDU-set quality requirement;
collecting network performance data from at least one other network node;
deriving, from the network performance data, quality of service sustainability analytics; and
sending the quality of service sustainability analytics to the analytics consumer.

12. A consumer of quality of service sustainability analytics in a wireless communication network, the consumer comprising:
at least one memory; and
at least one processor coupled with the at least one memory and configured to cause the consumer to:
send, to a network node, a request, the request comprising a protocol data unit (PDU)-set quality requirement, the request for analytics of quality of service sustainability for any quality of service (QoS) flow established satisfying the PDU-set quality requirement; and
receive, from the network node, quality of service sustainability analytics.

13. The consumer of claim 12, wherein the at least one processor is further configured to determine whether the PDU-set quality requirement for a QoS flow is sustainable.

14. The consumer of claim 12, wherein the at least one processor is further configured to determine that the PDU-set quality requirement for a QoS flow is unsustainable, and adjust the requested PDU-set quality requirement for the QoS flow.

15. The consumer of claim 14, wherein adjusting the requested PDU-set quality requirement for the QoS flow comprises at least one of:
adjusting the quality of a video carried by the QoS flow;
changing an encoder configuration;
changing a PDU-set grouping configuration;
changing a Forward Error Correction (FEC) codec redundancy; or
changing a source block size.

16. The consumer of claim 12, wherein the PDU-set quality requirement defines a quality of service threshold.

17. The consumer of claim 12, wherein the PDU-set quality requirement is defined as a 5G QoS Identifier (5QI).

18. The consumer of claim 12, wherein the PDU-set quality requirement comprises a quality requirement for a class of PDU-set or a PDU-set QoS requirement.

19. (canceled)

20. The consumer of claim 12, wherein the derived quality of service sustainability analytics are filtered to be limited to QoS flows satisfying the PDU-set quality requirement.

21. (canceled)

22. A method performed by a consumer of quality of service sustainability analytics, the method comprising:
sending, to a network node, a request, the request comprising a protocol data unit (PDU)-set quality requirement, the request for analytics of quality of service sustainability for any quality of service (QoS) flow established satisfying the PDU-set quality requirement;
receiving from the network node quality of service sustainability analytics.
